(19) United States
(12) Patent Application Publication
(10) Pub. No.: US 2005/0186349 A1
(43) Pub. Date: Aug. 25, 2005

(54) Scratch and mar resistant low VOC coating composition

(76) Inventors: Scott W. Loper, Canton, MI (US); Peter William Uhlianuk, Romeo, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/115,468

(22) Filed: Apr. 27, 2005

Related U.S. Application Data
(62) Division of application No. 10/391,133, filed on Mar. 18, 2003.

(51) Int. Cl. B05D 3/02

(52) U.S. Cl. 427/372.2

(57) ABSTRACT

A curable coating composition, and process of application thereof, particularly useful as a clearcoating applied over a pigmented basecoat that has significantly decreased VOC and improved scratch, etch, and mar resistance, is provided in accordance with the present invention, which is contains a silane functional oligomeric or polymeric material comprising carbamate groups and a crosslinking component comprising groups that are reactive with the carbamate groups.

### BACKGROUND OF THE INVENTION

1. Field of the Invention

This invention is directed to coating compositions, in particular to a coating composition containing a silane functional carbamate resin used as a clearcoat over a color or base coat, that has decreased VOC and improved scratch and mar resistance, as well as acid etch resistance.

2. Description of the Related Art

In many geographic regions, acid rain and other air pollutants have caused water spotting and acid etching of finishes used on automobiles and trucks. In the time period immediately after the finish has been applied and cured, the sensitivity to spotting and etching is highest. The finish of choice presently being used on the exterior of automobiles and trucks is an etch resistant clearcoat/colorcoat finish in which a clearcoating is applied over a color coating or base coating which is pigmented to provide protection to the colorcoat and improve the appearance of the overall finish particularly gloss and distinctness of image.

A problem with some etch resistant clearcoats is poor scratch and mar resistance. This is especially the case in the post cure period from when the vehicle is completed at the assembly plant and subsequently delivered to the new car dealer. Such scratching and marring may be caused by applying typical mechanical forces to the recently cured finish, such as washing, wiping, or even contact with jewelry.

Decreasing VOC, or volatile organic compound, content in coatings has been a general direction and requirement in the OEM finishes marketplace. Suppliers and OEM customers are continuously encouraged to decrease the VOC content at any opportunity. As such, it is highly valued to have decreased VOC in any new product offering.

Many etch resistant clearcoating compositions have been described or commercialized. However, none of the compositions shown in the above patents have the necessary combination of properties that are desired for an automotive OEM clearcoating composition with significantly decreased VOC which also has increased etch, mar and scratch resistance.

It is desirable, therefore, for coating compositions which form finishes resistant to environmental etching as well as scratching and marring, while exhibiting significantly decreased VOC content.

### SUMMARY OF THE INVENTION

A curable coating composition is provided in accordance with the present invention, which contains a silane functional oligomeric or polymeric material containing carbamate groups, and a crosslinking component with groups that are reactive with the carbamate functional groups.

The invention also includes a process for coating a substrate with the above coating composition. The claimed invention further includes a substrate having adhered thereto a coating according to the above composition.

The composition of the present invention may be useful as a pigmented monocoat or basecoat, and may be especially useful for forming a clearcoat over a pigmented basecoat. Such a clear topcoat can be applied over a variety of colorcoats, such as water or organic solvent based colorcoats or powder colorcoats.

### DETAILED DESCRIPTION

The coating composition of the present invention is useful as a pigmented monocoat, or clearcoat or pigmented colorcoat in a basecoat-clearcoat composite coating. In particular, the coating composition of this invention is most usefuil as a clearcoating composition that is applied over a pigmented colorcoat. Basecoat-clearcoat finishes are conventionally used on the exterior of automobiles and trucks. The coating composition of the present invention forms a clear finish, which has improved scratch and mar resistance, environmental etch resistance, as well as decreased volatile organic content (VOC).

The invention is based on the discovery that incorporating a silane functionality into oligomeric or polymeric materials which are also carbamate functional, as contrasted with the conventional approach of incorporating hydroxyl functional groups therein, results in oligomeric or polymeric materials with excellent crosslinking capability with standard monomeric or polymeric melamine crosslinkers, while possessing significantly decreased solution viscosity. Such decreased polymer viscosity in turn provides a coatings composition viscosity decrease, or conversely, higher spray solids and lower volatile organic content (VOC). Further, the presence of the carbamate group in a coatings composition further improves marring and scratch resistance. The coatings are especially useful in automotive clearcoating compositions.

Another important characteristic of this invention is that a silane functional oligomeric or polymeric material which contains carbamate groups may be prepared in an efficient single step reaction in which the monomer mixture is gradually added to a refluxing premix of solvent containing mono-functional alcohol. U.S. Pat. No. 6,235,858 describes the preparation of carbamate functional acrylic polymers useful in automotive clearcoats. However, the polymers are prepared in two steps. The first step involves preparation of a primary carbamate functional acrylic monomer. In the second step, the carbamate monomer is radically copolymerized with other co-monomers to form the carbamate functional acrylic resin. The present invention, however, provides a single step polymerization, which is novel and significantly more efficient for preparing a silane functional oligomeric or polymeric material containing carbamate groups.

The clearcoat composition of this invention contains about 40 to 80%, preferably 55 to 70%, by weight of a film forming binder and correspondingly about 20 to 60%, preferably 30 to 45%, of a volatile organic liquid carrier which usually is a solvent for the binder and volatilizes at 35° C. and above. The clearcoat also can be in dispersion form. The film forming binder of the clearcoat composition contains 40 to 85% by weight, based upon the weight of binder, of a silane functional oligomeric or polymeric material containing carbamate groups (or silane functional carbamate resin) and correspondingly 15 to 60% by weight, based upon the weight of binder, of a crosslinking component with groups which are reactive with carbamate functional groups.

In a preferred embodiment, the silane functional carbamate resin is the polymerization product of about 10 to 85%, preferably 40 to 70%, by weight of polymerized monomers selected from the group consisting of an alkyl methacrylate, an alkyl acrylate, each having 1 to 12 carbon atoms in the alkyl group, or other polymerizable nonsilane-containing monomers; about 10 to 65%, preferably 20 to 40%, by weight of a mono-ethylenically unsaturated silane monomer; about 5 to 25%, preferably 10 to 20%, by weight of a mono-ethylenically unsaturated isocyanate monomer; and an effective amount, preferably at least a molar equivalent amount, of mono-functional alcohol to react with the isocyanate group on said mono-ethylenically unsaturated isocyanate monomer. The silane functional carbamate resin has a weight average molecular weight of about 500 to 30,000, preferably about 1,000 to 20, 000, more preferably 3,000 to 15,000, as determined by gel permeation chromatography (GPC) using polystyrene as the standard.

Suitable alkyl methacrylate monomers that can be used to form the organosilane polymer are methyl methacrylate, ethyl methacrylate, propyl methacrylate, butyl methacrylate, isobutyl methacrylate, pentyl methacrylate, hexyl methacrylate, octyl methacrylate, nonyl methacrylate, lauryl methacrylate and the like. Suitable alkyl acrylate monomers include methyl acrylate, ethyl acrylate, propyl acrylate, butyl acrylate, isobutyl acrylate, pentyl acrylate, hexyl acrylate, octyl acrylate, nonyl acrylate, lauryl acrylate and the like. Cycloaliphatic methacrylates and acrylates also can be used, such as trimethylcyclohlexyl methacrylate, trimethylcyclohexyl acrylate, isobomyl acrylate, isobomyl methacrylate, iso-butyl cyclohexyl methacrylate, t-butyl cyclohexyl acrylate, and t-butyl cyclohexyl methacrylate. Aryl acrylate and aryl methacrylates also can be used, such as benzyl acrylate and benzyl methacrylate. Mixtures of two or more of the above-mentioned monomers are also suitable.

In addition to alkyl acrylates and methacrylates, other polymerizable nonsilane-containing monomers, up to about 20% by weight of the polymer, can be used in the acrylosilane polymer for the purpose of achieving the desired properties such as hardness; appearance; mar, etch and scratch resistance, and the like. Exemplary of such other monomers are styrene, methyl styrene, acrylamide, acrylonitrile, methacrylonitrile, and the like.

A silane-containing monomer useful in forming the acrylosilane polymer is an alkoxysilane having the following structural formula: 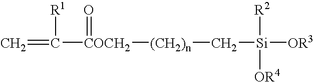
wherein R¹ is either H, CH₃, or CH₃CH₂; R² is either CH₃, CH₃CH₂, CH₃O, or CH₃CH₂O; R³ and R⁴ are CH₃ or CH₃CH₂; and n is 0 or a positive integer from 1 to 10.

Typical examples of such alkoxysilanes are the acryloxy alkyl silanes, such as gamma-acryloxypropyl-trimethoxysilane and the methacryloxy alkyl silanes, such as gamma-methacryloxypropyltrimethoxysilane, and gamma-methacryloxypropyltris(2-methoxyethoxy)silane.

Other suitable alkoxysilane monomers have the following structural formula: 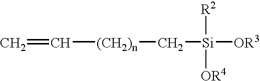
wherein R² is either CH₃, CH₃CH₂, CH₃O, or CH₃CH₂O; R³ and R⁴ are CH₃ or CH₃CH₂; and n is 0 or a positive integer from 1 to 10.

Examples of such alkoxysilanes are the vinylalkoxysilanes, such as vinyltrimethoxysilane, vinyltriethoxysilane and vinyltris(2-methoxyethoxy)silane. Other examples of such alkoxysilanes are the allylalkoxysilanes such as allyltrimethoxysilane and allyltriethoxysilane.

Additionally, further useful silane-containing monomers are acyloxysilanes, including acryloxysilane, methacryloxysilane and vinylacetoxysilanes, such as vinylmethyldiacetoxysilane, acryloxypropyltriacetoxysilane, and methacryloxypropyltriacetoxysilane. Mixtures of silane containing monomers are also suitable.

Silane functional macromonomers also can be used in forming the silane polymer. These macromonomers are the reaction product of a silane-containing compound, having a reactive group such as epoxide or isocyanate, with an ethylenically unsaturated non-silane-containing monomer having a reactive group, typically a hydroxyl or an epoxide group, that is co-reactive with the silane monomer. An example of a useful macromonomer is the reaction product of a hydroxy functional ethylenically unsaturated monomer such as a hydroxyalkyl acrylate or methacrylate having 1-8 carbon atoms in the alkyl group and an isocyanatoalkyl alkoxysilane such as isocyanatopropyltriethoxysilane.

Typical of such silane-functional macromonomers are those having the following structural formula: 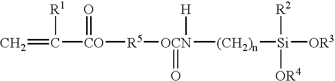
wherein R¹ is H or CH₃; R² is either CH₃ , CH₃CH₂, CH₃O, or CH₃CH₂O; R³ and R⁴ are CH₃ or CH₃CH₂; R⁵is an alkylene group having 1-8 carbon atoms; and n is 0 or a positive integer from 1 to 10.

The silane functional carbamate resin of the present invention may be prepared with a mono-ethylenically unsaturated isocyanate monomer. Suitable mono-ethylenically unsaturated isocyanate monomers include isocyanato ethyl methacrylate, dimethyl meta-isopropenyl benzyl isocyanate [meta-TMI], and the like. Mixtures of two or more of the above-mentioned mono-ethylenically unsaturated isocyanate monomers are also suitable. A particularly useful mono-ethylenically unsaturated isocyanate monomer is isocyanato ethyl methacrylate, due to its commercial availability.

During polymerization of the silane functional carbamate resin of the present invention, a mono-functional alcohol may be reacted with the mono-ethylenically unsaturated isocyanate monomer to form a secondary carbamate functional group. Typical structures of the secondary carbamnate are represented by the following formulas: 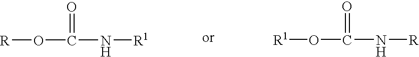
wherein R is a silane functional oligomeric or polymeric material, and R¹ is a mono functional alcohol. Suitable mono functional alcohols include n-butanol, methanol, ethanol, 2-ethyl hexanol, cyclohexanol, n-propanol, iso-propanol, iso-butanol and the like. Mixtures of two or more of the above-mentioned alcohols are also suitable. A particularly useful alcohol is n-butanol, due to its ideal boiling point for solution polymerization.

The clearcoat compositions of this invention contain from about 15 to 60%, preferably 20 to 40%, by weight, based on the weight of the binder, of a crosslinking component with groups which are reactive with carbamate functional groups. Such crosslinking components may be a conventional monomeric or polymeric alkylated melamine formaldehyde crosslinking resin that is partially or fully alkylated. In a preferred embodiment, the crosslinking component is an alkoxylated monomeric melamine formaldehyde resin that has a degree of polymerization of about 1-3. Generally, this melamine formaldehyde resin contains about 50% butylated groups or isobutylated groups and 50% methylated groups. Such crosslinking resins typically have a number average molecular weight of about 300-600 and a weight average molecular weight of about 500-1500. Some other examples of suitable commercially available melamine crosslinking resins are “Cymel” 1168, “Cymel” 1161, “Cymel” 1158, “Cymel” 303,“Resimine” 4514, “Resimine” 747 or “Resimine” 354.

The present coating composition further comprises an effective amount of catalyst, from about 0.1 to 5 weight percent, based on the weight of the binder, preferably from about 0.5 to 3 weight percent, based on the weight of the binder, more preferably from about 0.7 to 2 weight percent, based on the weight of the binder, to catalyze the crosslinking reactions of the silane moieties of the silane polymer with itself and other components of the composition. A wide variety of catalysts can be used, such as dibutyl tin dilaurate, dibutyl tin dilaurate, dibutyl tin diacetate, dibutyl tin dioxide, dibutyl tin dioctoate, tin octoate, aluminum titanate, aluminum chelates, zirconium chelate and the like. Sulfonic acids, such as dodecylbenzene sulfonic acid, either blocked or unblocked, are effective catalysts. Alkyl acid phosphates, such as phenyl acid phosphate, either blocked or unblocked, may also be employed. Any mixture of the aforementioned catalysts may be useful, as well. Other useful catalysts will readily occur to one skilled in the art.

In addition to the silane functional carbamate resin and crosslinking components described above, other film-forming and/or crosslinking solution polymers can be included in the binder component of the composition of the present application. Examples include conventionally known acrylics, cellulosics, aminoplasts, urethanes, polyesters, epoxides or mixtures thereof. One preferred optional film-forming polymer is a polyol, for example, an acrylic polyol solution polymer of polymerized monomers. Such monomers can include any of the aforementioned alkyl acrylates and/or methacrylates and, in addition, hydroxy alkyl acrylates or methacrylates. The polyol polymer preferably has a hydroxyl number of about 50-200 and a weight average molecular weight of about 1,000-200,000 and preferably about 1,000-20,000.

To provide the hydroxy functionality in the polyol, up to about 90% by weight, preferably 20 to 50%, of the polyol comprises hydroxy functional polymerized monomers. Suitable monomers include hydroxyalkyl acrylates and methacrylates, for example, such as the hydroxy alkyl acrylates and methacrylates listed herein above and mixtures thereof.

Other polymerizable monomers can be included in the polyol polymer, in an amount up to about 50% by weight. Such polymerizable monomers include, for example, styrene, methylstyrene, acrylamide, acrylonitrile, methacrylonitrile, methacrylamide, methylol methacrylamide, methylol acrylamide and the like, and mixtures thereof.

In addition to the above components in the coatings composition of the invention, crosslinked polymer microparticles may optionally be included.

This component of the coating composition is a crosslinked polymer dispersed in an organic (substantially non-aqueous) medium. This component has been described heretofore as a non-aqueous dispersion (NAD) polymer, a microgel, a non-aqueous latex, or a polymer colloid. In general, the dispersed polymer is stabilized by steric stabilization accomplished by the attachment of a solvated polymeric or oligomeric layer at the particle medium interface.

In the dispersed polymers of the present composition, the dispersed phase or particle, sheathed by a steric barrier, will be referred to as the “macromolecular polymer” or “core”. The stabilizer forming the steric barrier, attached to this core, will be referred to as the “macromonomer chains” or “arms”.

The dispersed polymers solve the problem of cracking typically associated with silane coatings and are used in an amount varying from about 0 to 60% by weight, preferably about 5 to 30%, more preferably about 10 to 20%, of the total binder in the composition. The ratio of the silane compound to the dispersed polymer component of the composition suitably ranges from 5:1 to 1:2, preferably 4:1 to 1:1. To accommodate these relatively high concentrations of dispersed polymers, it is desirable to have reactive groups on the arms of the dispersed polymer, which reactive groups make the polymers compatible with the continuous phase of the system.

The dispersed polymer preferably contains about 10-90%, more preferably 50-80%, by weight, based on the weight of the dispersed polymer, of a high molecular weight core having a weight average molecular weight of about 50,000-500,000. The preferred average particle size is 0.05 to 0.5 microns. The arms, attached to the core, make up about 10-90%, preferably 20-59%, by weight of the dispersed polymer, and have a weight average molecular weight of about 1,000-30,000, preferably 1,000 to 10,000.

The macromolecular core of the dispersed polymer typically comprises polymerized ethylenically unsaturated monomers. Suitable monomers include styrene, alkyl acrylate or methacrylate, ethylenically unsaturated monocarboxylic acid, and/or silane-containing monomers. Such monomers as methyl methacrylate contribute to high Tg (glass transition temperature) whereas such monomers as butyl acrylate or 2-ethylhexyl acrylate contribute to low Tg. Other optional monomers are hydroxyalkyl acrylates, methacrylates or acrylonitrile. Such functional groups as hydroxy in the core can react with silane groups in the silane compound to produce additional bonding within the film matrix. If a crosslinked core is desired, allyl diacrylate or allyl methacrylate can be used. Alternatively, an epoxy functional monomer such as glycidyl acrylate or methacrylate can be used to react with monocarboxylic acid-functional co-monomers and crosslink the core; or the core can contain silane functionality.

A preferred feature of the dispersed polymers is the presence of macromonomer arms which contain hydroxy groups adapted to react with the organosilane compound. It is not known with certainty what portion of these hydroxy functional groups react with the organosilane compound because of the numerous and complicated sets of reactions that occur during baking and curing. However, it can be said that a substantial portion of these functionality's in the arms, preferably the majority thereof, do react and crosslink with the film-former of the composition, which in some cases can exclusively consist of an organosilane compound.

The arms of the dispersed polymer should be anchored securely to the macromolecular core. For this reason, the arms preferably are anchored by covalent bonds. The anchoring must be sufficient to hold the arms to the dispersed polymer after they react with the film-former compound. For this reason, the conventional method of anchoring by adsorption of the backbone portion of a graft polymer may be insufficient.

The arms or macromonomers of the dispersed polymer serve to prevent the core from flocculating by forming a steric barrier. The arms, typically in contrast to the macromolecular core, are believed capable, at least temporarily, of being solvated in the organic solvent carrier or media of the composition. They can be in chain-extended configuration with their hydroxy functional groups available for reaction with the silane groups of the film-forming silane-containing compound and polymer. Such arms comprise about 3 to 30% by weight, preferably 10 to 20%, based on the weight of macromonomer, of polymerized ethylenically unsaturated hydroxy functionality-containing monomers, and about 70-95% by weight, based on the weight of the macromonomer, of at least one other polymerized ethylenically unsaturated monomer without such crosslinking functionality. Combinations of such hydroxy monomers with other lesser amounts of crosslinking functional groups, such as silane or epoxy, on the arms are also suitable.

The macromonomer arms attached to the core can contain polymerized monomers of alkyl methacrylate, alkyl acrylate, each having 1-12 carbon atoms in the alkyl group, as well as glycidyl acrylate or glycidyl methacrylate or ethylenically unsaturated monocarboxylic acid for anchoring and/or crosslinking. Typical useful hydroxy-containing monomers are hydroxyalkyl acrylates or methacrylates.

A preferred composition for a dispersed polymer that has hydroxy functionality comprises a core consisting of about 25% by weight of hydroxyethyl acrylate, about 4% by weight of methacrylic acid, about 46.5% by weight of methyl methacrylate, about 18% by weight of methyl acrylate, about 1.5% by weight of glycidyl methacrylate and about 5% of styrene. The macromonomer attached to the core contains 97.3% by weight of pre-polymer and about 2.7% by weight of glycidyl methacrylate, the latter for crosslinking or anchoring.

A preferred pre-polymer contains about 28% by weight of butyl methacrylate, about 15% by weight of ethyl methacrylate, about 30% by weight of butyl acrylate, about 10% by weight of hydroxyethyl acrylate, about 2% by weight of acrylic acid, and about 15% by weight of styrene.

The dispersed polymer can be produced by well known dispersion polymerization of monomers in an organic solvent in the presence of a steric stabilizer for the particles. The procedure has been described as one of polymerizing the monomers in an inert solvent in which the monomers are soluble but the resulting polymer is not soluble, in the presence of a dissolved amphoteric stabilizing agent.

Suitable dispersed polymers for use herein are also disclosed in U.S. Pat. No. 5,162,426, hereby incorporated by reference.

Conventional solvents and diluents can be employed as carriers in the composition of this invention to aid sprayability, flow, and leveling. Typical carriers include toluene, xylene, butyl acetate, acetone, methyl isobutyl ketone, methyl ethyl ketone, methanol, isopropanol, butanol, hexane, acetone, ethylene glycol monoethyl ether, VM&P® naphtha, mineral spirits, heptane and other aliphatic, cycloaliphatic, aromatic hydrocarbons, esters, ethers, ketones, and the like. They can be used in amounts of 0 to about 4 pounds (or higher) per gallon of coating composition. Preferably, they are employed in amounts not exceeding about 3.5 pounds per gallon of composition. Other useful carriers will be readily apparent to those skilled in the art.

To improve weatherability of a clear finish produced by the present coating composition, an ultraviolet light stabilizer or a combination of ultraviolet light stabilizers can be added in the amount of about 0.1-5% by weight based on the weight of the binder. Such stabilizers include ultraviolet light absorbers, screeners, quenchers, and hindered amine light stabilizers. Also, an antioxidant can be added in the amount of about 0.1-5% by weight based on the weight of the binder. Typical ultraviolet light stabilizers include benzophenones, triazoles, triazines, benzoates, hindered amines and mixtures thereof.

The composition can also include flow control agents such as Resiflow S (acrylic terpolymer solution), BYK 320 and 325 (silicone additives); rheology control agents such as microgel (acrylic microgel), cellulose acetate butyrate, and fumed silica; water scavenger such as tetrasilicate, trimethylorthoformate, triethylorthoformate, and the like.

When the present coating composition is used as a clearcoat (topcoat) over a pigmented colorcoat (basecoat) to provide a basecoat/clearcoat finish, small amounts of pigment can be added to the clearcoat to eliminate undesirable color in the finish such as yellowing.

The present composition also can be highly pigmented and used as the basecoat. When the coating composition is used as a basecoat, typical pigments that can be added include the following: metallic oxides such as titanium dioxide, zinc oxide, iron oxides of various colors, carbon black, filler pigments such as talc, china clay, barytes, carbonates, silicates and a wide variety of organic colored pigments such as quinacridones, copper phthalocyanines, perylenes, azo pigments, indanthrone blues, carbazoles such as carbazole violet, isoindolinones, isoindolones, thioindigo reds, benzimidazolinones, metallic flake pigments such as aluminum flake, and the like.

The pigments can be introduced into the coating composition by first forming a mill base or pigment dispersion with any of the aforementioned polymers used in the coating composition or with another compatible polymer or dispersant by conventional techniques, such as high speed mixing, sand-grinding, ball-milling, attritor-grinding or two-roll-milling. The mill base is then blended with the other constituents used in the coating composition.

The coating composition can be applied by conventional techniques such as spraying, electrostatic spraying, dipping, brushing, flowcoating and the like. The preferred techniques are spraying and electrostatic spraying. After application, the composition is typically baked at 100- 150° C. for about 15-30 minutes to form a coating about 0.1-3.0 mils thick. When the composition is used as a clearcoat, it is applied over the colorcoat which can be dried to a tack-free state and cured or preferably flash-dried for a short period before the clearcoat is applied. It is customary to apply a clear topcoat over a solvent-borne basecoat by means of a “wet-on-wet” application, i.e., the topcoat is applied to the basecoat without completely drying the basecoat. The coated substrate is then heated for a predetermined time period to allow simultaneous curing of the base and clearcoats. Application over water-borne basecoat normally requires some period of drying of the basecoat before application of the clearcoat.

The coating composition of this invention is typically formulated as a one-package system although two-package systems are possible as will occur to one skilled in the art. The one-package system has been found to have extended shelf life.

For a typical auto or truck body, steel sheet is used or a plastic or a composite can be used. If steel is used, it is first treated with an inorganic rust-proofing compound such as zinc or iron phosphate and then a primer coating is applied by electrodeposition. Typically, these electrodeposition primers are epoxy modified resins crosslinked with a polyisocyanate and are applied by a cathodic electrodeposition process. Optionally, a primer surfacer can be applied over the electrodeposited primer usually by spraying to provide for better appearance and/or improved adhesion of the basecoat to the primer. A pigmented basecoat or colorcoat then is applied. A typical colorcoat comprises pigment which can include metallic flake pigments such as aluminum flake or pearl flake pigments, a film forming binder which can be a polyurethane, an acrylourethane, a polyester polymer, an acrylic polymer or a silane polymer, and contains a crosslinking agent such as an aminoplast, typically, an alkylated melamine formaldehyde crosslinking agent or a polyisocyanate. The basecoat can be solvent or water borne and can be in the form of a dispersion or a solution.

### EXAMPLES

The following Examples illustrate the invention. All parts and percentages are on a weight basis unless otherwise indicated. All molecular weights disclosed herein are determined by GPC using a polystyrene standard.

The following polymers were prepared and used in Examples 1, 2, & 3 and Comparative Example 4.

Preparation of Carbamate Functional Acrylosilane Polymer A

A carbamate functional acrylosilane resin was prepared by charging the following to a nitrogen blanketed flask equipped with a trap & reflux condenser, agitator, thermocouple, and heating mantel:

| | Parts |
|---|---|
| | by Weight |
| Portion I | |
| Solvesso 100 Aromatic Hydrocarbon solvent | 401.70 |
| n-Butanol | 293.10 |
| Vinyl Trimethoxy Silane (Silquest ® A-171 from Crompton) | 110.32 |
| Portion II | |
| Solvesso 100 Aromatic Hydrocarbon solvent | 151.24 |
| Vazo ® 67 (from DuPont) | 78.11 |
| Styrene | 110.40 |
| iso-Butyl Methacrylate | 276.02 |
| n-Butyl Acrylate | 275.80 |
| Isocyanato Ethyl Methacrylate (from Kowa American) | 331.00 |
| Portion III | |
| Solvesso 100 Aromatic Hydrocarbon solvent | 17.60 |
| Vazo ® 67 (from DuPont) | 9.76 |
| n-Butanol | 10.48 |
| Total | 1908.15 |

Portion I was charged into the reaction flask and heated to reflux temperature under agitation and a nitrogen blanket. Portion II was premixed and added to Portion I over a 4 hour period. Portion III was premixed and subsequently added over 30 minutes. The solution was then held at reflux for 2 hours. The resulting polymer solution was then cooled to room temperature.

The resulting polymer solution has a 67.5% solids content and a viscosity of 158 centipoise measured at 25° C., and has a weight average molecular weight of 3,426.

Preparation of Carbamate Functional Acrylosilane Polymer B

A carbamate functional acrylosilane resin was prepared by charging the following to a nitrogen blanketed flask equipped with a trap & reflux condenser, and a mixer:

| | Parts |
|---|---|
| | by Weight |
| Portion I | |
| Solvesso 100 Aromatic Hydrocarbon solvent | 285.00 |
| n-Butanol | 214.42 |
| Portion II | |
| Solvesso 100 Aromatic Hydrocarbon solvent | 151.24 |
| Vazo ® 67 (from DuPont) | 78.11 |
| Styrene | 276.02 |
| iso-Butyl Methacrylate | 276.02 |
| n-Butyl Acrylate | 55.16 |
| Isocyanato Ethyl Methacrylate (from Kowa American) | 165.49 |
| Gamma-methacryloxypropyl trimethoxysilane monomer | 330.98 |
| (TPM) | |
| (A-174 from Crompton) | |
| Portion III | |
| Solvesso 100 Aromatic Hydrocarbon solvent | 17.60 |
| Vazo ® 67 (from DuPont) | 9.76 |
| n-Butanol | 10.48 |
| Total | 1791.50 |

Portion I was charged into the reaction flask and heated to reflux temperature under agitation and a nitrogen blanket. Portion II was premixed and added to Portion I over a 4 hour period. Portion III was premixed and subsequently added over 30 minutes. The solution was then held at reflux for 2 hours. The resulting polymer solution was then cooled to room temperature.

The resulting polymer solution has a 67.5% solids content and a viscosity of 160 centipoise measured at 25 degree C., and has a weight average molecular weight of 3829.

Preparation of Carbamate Functional Acrylosilane Polymer C

A carbamate functional acrylosilane resin was prepared by charging the following to a nitrogen blanketed flask equipped as above:

| | Parts |
|---|---|
| | by Weight |
| Portion I | |
| Solvesso 100 Aromatic Hydrocarbon solvent | 200.00 g |
| n-Butanol | 193.00 g |
| Portion II | |
| Solvesso 100 Aromatic Hydrocarbon solvent | 151.24 |
| Vazo ® 67 (from DuPont) | 78.11 |
| Styrene | 110.40 |
| iso-Butyl Methacrylate | 276.02 |
| n-Butyl Acrylate | 55.16 |
| Isocyanato Ethyl Methacrylate (from Kowa American) | 331.00 |
| Gamma-methacryloxypropyl trimethoxysilane monomer | 330.98 |
| (TPM) | |
| (A-174 from Crompton) | |
| Portion III | |
| Solvesso 100 Aromatic Hydrocarbon solvent | 17.60 |
| Vazo ® 67 (from DuPont) | 9.76 |
| n-Butanol | 10.48 |
| Total | 1763.73 |

Portion I was charged into the reaction flask and heated to reflux temperature under agitation and a nitrogen blanket. Portion II was premixed and added to Portion I over a 4 hour period. Portion III was premixed and subsequently added over 30 minutes. The solution was then held at reflux for 2 hours. The resulting polymer solution was then cooled to room temperature.

The resulting polymer solution has a 67.5% solids content and a viscosity of 348 centipoise measured at 25° C., and has a weight average molecular weight of 4114.

Preparation of Acrylosilane Polymer

A hydroxy functional acrylosilane resin was prepared by charging the following to a nitrogen blanketed flask equipped as above:

| | Parts |
|---|---|
| | by Weight |
| Portion I | |
| Solvesso 100 Aromatic Hydrocarbon solvent | 83.90 |
| n-Butanol | 67.65 |
| Portion II | |
| Solvesso 100 Aromatic Hydrocarbon solvent | 84.43 |
| Vazo ® 67 (from DuPont) | 43.94 |
| Styrene | 138.02 |
| iso-Butyl Methacrylate | 126.92 |
| Hydroxy Propyl Acrylate | 110.37 |
| n-Butyl Acrylate | 11.04 |
| Gamma-methacryloxypropyl trimethoxysilane monomer | 165.49 |
| (TPM) | |
| Silquest ® (A-174 from Crompton) | |
| n-Butanol | 5.25 |
| Total | 837 |

Portion I was charged into the reaction flask and heated to reflux temperature under agitation and a nitrogen blanket. Portion II was premixed and added to Portion I over a 4 hour period. The solution was then held at reflux for 2 hours. The resulting polymer solution was then cooled to room temperature.

The resulting polymer solution has a 67.5% solids content and a viscosity of 2741 centipoise measured at 25° C., and has a weight average molecular weight of 7350.

Preparation of an Acrylic Microizel Resin

An acrylic microgel resin was prepared by charging the following to a nitrogen blanketed flask equipped as above:

| | Parts |
|---|---|
| | by Weight |
| Portion I | |
| 2,2′-azobis(2-methylbutyronitrile) | 1.395 |
| Methyl methacrylate/Glycidyl methacrylate copolymer | 4.678 |
| (PPG Industries Super Stabilizer HCM-8788) | |
| Methyl methacrylate | 15.187 |
| Mineral spirits | 97.614 |
| (Exxon Chemical Exxsol D40) | |
| Heptane | 73.638 |
| Portion II | |
| Methyl methacrylate | 178.952 |
| Glycidyl methacrylate | 2.816 |
| Methacrylic acid | 2.816 |
| Methyl methacrylate/ | 58.271 |
| Glycidyl methacrylate copolymer | |
| (PPG Industries Super Stabilizer HCM-8788) | |
| N,N-dimethylethanolamine | 1.108 |
| Styrene | 75.302 |
| Hydroxy ethyl acrylate | 23.455 |
| Mineral Spirits | 32.387 |
| (Exxon Chemical Exxsol D40) | |
| Heptane | 205.078 |
| Portion III | |
| 2,2′-azobis(2-methylbutyronitrile) | 2.024 |
| Toluene | 12.938 |
| Heptane | 33.341 |
| Potion IV | |
| Melamine Resin | 246.300 |
| (Resimine ® 755 from Solutia, Inc.) | |

Portion I is charged into the reaction vessel, heated to its reflux temperature, and held for 1 hour. Portion II and Portion III are premixed separately and then added simultaneously over a 180 minute period to the reaction vessel mixed while maintaining the resulting reaction mixture at its reflux temperature. The resin solution is subsequently held at reflux temperature for 25 minutes, and then 246.300 parts by weight of solvent are striped off. The resin is then cooled to at least 3° C. below reflux, and then portion IV is added.

Preparation of an Acrylic NAD Resin

A hydroxy functional acrylic NAD resin was prepared by charging the following to a nitrogen blanketed flask equipped as above:

| | Parts |
|---|---|
| | by Weight |
| Portion I | |
| Isopropanol | 29.95 |
| Mineral spirits | 35.95 |
| (Exxon Chemical Exxsol D40) | |
| Heptane | 245.63 |
| Acrylic copolymer | 179.74 |
| (60% solids of an acrylic copolymer of | |
| 15% styrene, 20% butyl methacrylate, | |
| 38.5% ethyl hexyl methacrylate, 22.5% | |
| hydroxy ethyl acrylate, 4% acrylic acid, | |
| and 1.4% glycidyl methacrylate having a | |
| weight average molecular weight of | |
| 10,000 in a solvent blend of 77.5% | |
| solvesso 150 and 22.5% butanol) | |
| Portion II | |
| t-Butyl peroxy-2-ethyl hexanoate | 0.45 |
| Portion III | |
| Styrene | 35.95 |
| Methyl methacrylate | 194.71 |
| Acrylonitrile | 5.99 |
| Acrylic copolymer | 89.87 |
| (60% solids of an acrylic copolymer of | |
| 15% styrene, 20% butyl methacrylate, | |
| 38.5% ethyl hexyl methacrylate, 22.5% | |
| hydroxy ethyl acrylate, 4% acrylic acid, | |
| and 1.4% glycidyl methacrylate having a | |
| weight average molecular weight of | |
| 10,000 in a solvent blend of 77.5% | |
| solvesso 150 and 22.5% butanol) | |
| Hydroxy ethyl acrylate | 29.95 |
| Methyl acrylate | 14.98 |
| Glycidyl methacrylate | 5.99 |
| Acrylic acid | 11.98 |
| Isobutyl alcohol | 26.95 |
| Portion IV | |
| Mineral spirits | 20.97 |
| (Exxon Chemical Exxsol D40) | |
| Heptane | 26.96 |
| t-Butyl peroxy-2-ethyl hexanoate | 2.99 |
| Portion V | |
| Isobutyl alcohol | 41.94 |
| t-Butyl peroxy-2-ethyl hexanoate | 1.50 |

Portion I is charged into the reaction vessel and heated to reflux temperature. Portion II is then added to the reaction vessel within 5 minutes before Portions III and IV begin feeding into the reaction vessel. Portions III and IV are separately premixed, and simultaneously fed into the reaction vessel, at reflux temperature, over a 210 minute period. Portion V is premixed and added over a 60 minute period while maintaining reflux temperature. The reaction solution is then held at reflux temperature for 60 minutes. Vacuum is then applied to the reaction vessel, and 236.84 parts by weight solvent are stripped off.

The resulting NAD resin has a weight solids of 60%, a core having a weight average molecular weight of about 100,000-200,000 and arms attached to the core having a weight average molecular weight of about 10,000-15,000.

Preparation of an Acrvlic Polyol Resin

An acrylic polyol resin was prepared by charging the following to a nitrogen blanketed flask equipped as above:

| | Parts by Weight |
|---|---|
| Portion I | |
| Solvesso 100 | 181.868 |
| Portion II | |
| Hydroxy propyl acrylate | 230.196 |
| Butyl methacrylate | 180.569 |
| Styrene | 90.285 |
| Butyl acrylate | 100.85 |
| Solvesso 100 | 27.709 |
| Portion III | |
| t-Butyl peroxyacetate | 5.414 |
| Solvesso 100 | 35.109 |
| Total | 852.000 |

Portion I is charged into the reactor and heated to reflux temperature. Portions II and III are premixed separately and the added simultaneously to the reactor while the reaction mixture is held at reflux temperature, over a 180 minute period. The solution is then held at reflux temperature for 60 minutes.

The resulting acrylic polyol resin is 70% by weight solids, and has a weight average molecular weight of about 6,000.

Preparation of a Silica Dispersion

A silica dispersion was made by first preparing a dispersant polymer and then dispersing the silica by a grinding process. Silica Dispersion when used in following examples was prepared by this procedure.

| | Parts by Weight |
|---|---|
| Portion I | |
| Xylene | 165.794 |
| Portion II | |
| Butyl methacrylate monomer | 349.686 |
| Hydroxy propyl acrylate | 233.131 |
| Portion III | |
| t-Butyl peroxyacetate | 17.485 |
| Xylene | 28.615 |
| Portion IV | |
| Xylene | 4.995 |
| Portion V | |
| Xylene | 45.294 |
| Total | 845.000 |

Portion I was charged to the reaction vessel and heated to its reflux temperature. Then portion II was added over a 400 minute period simultaneously with portion III started at the same time as portion II but added over a 415 minute period, while maintaining the resulting reaction mixture at its reflux temperature. Then portion IV was added to the reactor and the reaction mixture was held at reflux for 40 minutes. Heating was removed and then portion V was added to thin the batch. The resulting acrylic dispersant resin was at 70.0% weight solids.

| | Parts by Weight |
|---|---|
| Portion VI | |
| Xylene | 35.000 |
| Butanol | 20.000 |
| Dispersant Resin | 36.000 |
| Portion VII | |
| Hydrophobic Amorphous Fused Silica | 9.000 |
| Silica | |
| Total | 100.000 |

Load portion VI to a horizontal media mill previously loaded with zirconia media at a level of 270 lbs for a 25 gallon mill. Maintain mill temperature at 100-120° F. Then add portion VII at slow speed followed by high speed grinding for 20 minutes. The dispersion was then filtered through a 10 micron filter to obtain the final product.

### Preparation of Clearcoat Examples 1-3 and Comparative Example 4

Clearcoat compositions were prepared by blending together the following ingredients in the order given:

PRODUCTION EXAMPLES

| INGREDIENTS (all amounts | | | | C. Ex. |
|---|---|---|---|---|
| parts by weight) | Ex. 1 | Ex. 2 | Ex. 3 | 4-Control |
| Acrylic microgel resin | 37.21 | 37.21 | 37.21 | 37.21 |
| Melamine formaldehyde resin | 13.64 | 13.64 | 13.64 | 13.64 |
| (Cymel ® 1168¹) | | | | |
| Melamine formaldehyde resin | 79.37 | 79.37 | 79.37 | 79.37 |
| (Cymel ® 1161¹) | | | | |
| n-Butanol | 50.97 | 50.97 | 50.97 | 50.97 |
| UV Absorber/Hindered Amine | 58.54 | 58.54 | 58.54 | 58.54 |
| Light Stabilizer solution | | | | |
| (5.5% xylene, 69.5% Solvesso | | | | |
| 100 aromatic solvent, | | | | |
| 8.5% Tinuvin ® 123², | | | | |
| 13.7% Tinuvin ® 928², 2.8% | | | | |
| Acrylic NAD resin | 165.36 | 165.36 | 165.36 | 165.36 |
| Resiflow S³ acrylic copolymer | 2.47 | 2.47 | 2.47 | 2.47 |
| flow additive | | | | |
| Dodecylbenzene Sulfonic Acid | 11.82 | 11.82 | 11.82 | 11.82 |
| Solution (33% solids in | | | | |
| n-butanol solution and | | | | |
| blocked with di-isopropanol | | | | |
| amine) | | | | |
| Silica Dispersion | 27.54 | 27.54 | 27.54 | 27.54 |
| Trimethylorthoformate | 12.40 | 12.40 | 12.40 | 12.40 |
| Acrylic polyol resin | 34.83 | 34.83 | 34.83 | 34.83 |
| Carbamate Functional | 324.85 | — | — | — |
| Acrylosilane Polymer A | | | | |
| Carbamate Functional | — | 324.85 | — | — |
| Acrylosilane Polymer B | | | | |
| Carbamate Functional | — | — | 324.85 | — |
| Acrylosilane Polymer C | | | | |
| Acrylosilane Polymer | — | — | — | 324.85 |

Sources of above constituents are:
¹Product of Cytec, Inc.
²Product of Ciba Specialty Chemical Company
³Product of Estron Corporation

Phosphated steel panels that had been electrocoated with an electrocoating primer was sprayed and coated respectively with conventional black solvent-borne base coating composition to form a basecoat about 0.5 to 1.0 mils thick. The basecoats were each given a flash of 5 minutes. Then the clearcoat paint formulated above was applied “wet-on-wet” over each of the basecoats to form a clearcoat layer about 1.5-2.5 mil thick. The panels were then fully cured by baking for 30 minutes at about 265° F.

The resulting clearcoats of the invention (Examples 1-3) were smooth and essentially free of craters and had excellent appearance and had higher spray solids and lower VOCs when compared to a control clearcoat prepared from a conventional acrylosilane resin. (see control Example 4).

Test Procedures

The following procedures were used to test the coated test panels.

Etching was tested by exposing the coated panel to 10% sulfuric acid for 15 minutes on a thermal gradient bar. Etch damage increased with intensity as the temperature on the gradient bar increased. The performance was rated relative to a “good” etch resistant control, a conventional acrylosilane resin based clearcoat composition.

Crockmeter Dry Mar Resistance was measured by marring the coating with a felt pad coated with Bon Ami® cleanser, supplied by Faultless Starch/Bon Ami Company. The marring was accomplished using a Daiei® Rub Tester. The test used 15 cycles with a weight of 700 grams. The Crocker Wet and Dry Mar resistance in percentages was reported by measuring the 20° gloss of the marred area of the panel before and after the test.

Test Results

The following properties of the coated test panels were measured and results are shown in Table 1, versus control Example 4.

TEST RESULTS

| PROPERTIES | Ex. 1 | Ex. 2 | Ex. 3 | C. Ex. 4 |
|---|---|---|---|---|
| Viscosity (#4 Ford Cup @ | 28 sec | 35 sec | 34 sec | 34 sec |
| 77 C.) - ASTM 1200 | | | | |
| Density (lbs/gal) - | 8.2 | 8.1 | 8.2 | 8.2 |
| ASTM D 1475 | | | | |
| Analytical weight % | 59.7 | 59.0 | 59.9 | 51.8 |
| nonvolatile - | | | | |
| ASTM D 2369 | | | | |
| Volume Organic Content | 3.3 | 3.3 | 3.3 | 3.9 |
| (lbs/gal) | | | | |
| Tukon Hardness (KHN) - | 11 | 10 | 11 | 11 |
| ASTM D 1474 | | | | |
| Gradient Bar Etch | Excellent | V. Good | V. Good | Good |
| Resistance | | | | |
| Crockmeter Dry Mar | 80% | 80% | 84% | 77% |
| Resistance (% gloss | | | | |
| retention) | | | | |

The above results show that the clearcoats of the invention also have better scratch, etch and mar resistance when compared to the control clearcoat prepared from a conventional acrylosilance resin. (See control Example 4).

Various modifications, alterations, additions or substitutions of the components of the compositions of this invention will be apparent to those skilled in the art without departing from the spirit and scope of this invention. This invention is not limited by the illustrative embodiments set forth herein, but rather is defined by the following claims.

1-11. (canceled)

12. A substrate coated with a dried and cured coating composition derived from about 40% to 80% by weight of film forming binder and from about 20% to 60% by weight of a volatile liquid carrier for said binder; wherein said binder comprises:
(a) from about 40% to 85% by weight, based on the weight of the binder solids, of a silane functional oligomeric or polymeric material comprising carbamate groups, prepared from a mixture comprising:
I) from about 10 to 85% by weight of polymerized monomers selected from the group consisting of an alkyl methacrylate, an alkyl acrylate, each having 1 to 12 carbon atoms in the alkyl group, cycloaliphatic alkyl methacrylate, cycloaliphatic alkyl acrylate, styrene or any mixture of these monomers;
II) from about 10 to 65% by weight of a mono-ethylenically unsaturated silane monomer;
III) from about 5 to 25% by weight of a mono-ethylenically unsaturated isocyanate monomer; and
IV) an effective amount of a mono-functional alcohol to react with the isocyanate group on said mono-ethylenically unsaturated isocyanate monomer; and
wherein said silane functional oligomeric or polymeric material comprising carbamate groups has a weight average molecular weight of 500 to 30,000, as determined by gel permeation chromatography;
(b) from about 15% to 60% by weight, based on the weight of the binder solids, of a crosslinking component comprising a plurality of groups that are reactive with the carbamate groups of component (a); and
(c) from about 10 to 30% by weight, based upon the weight of the binder, of a polymer microparticle dispersion.

13. An automobile or truck exterior body coated with the dried and cured composition derived from about 40% to 80% by weight of film forming binder and from about 20% to 60% by weight of a volatile liquid carrier for said binder; wherein said binder comprises:
(a) from about 40% to 85% by weight, based on the weight of the binder solids, of a silane functional oligomeric or polymeric material comprising carbamate groups, prepared from a mixture comprising:
I) from about 10 to 85% by weight of polymerized monomers selected from the group consisting of an alkyl methacrylate, an alkyl acrylate, each having 1 to 12 carbon atoms in the alkyl group, cycloaliphatic alkyl methacrylate, cycloaliphatic alkyl acrylate, styrene or any mixture of these monomers;
II) from about 10 to 65% by weight of a mono-ethylenically unsaturated silane monomer;
III) from about 5 to 25% by weight of a mono-ethylenically unsaturated isocyanate monomer; and
IV) an effective amount of a mono-functional alcohol to react with the isocyanate group on said mono-ethylenically unsaturated isocyanate monomer; and
wherein said silane functional oligomeric or polymeric material comprising carbamate groups has a weight average molecular weight of 500 to 30,000, as determined by gel permeation chromatography;
(b) from about 15% to 60% by weight, based on the weight of the binder solids, of a crosslinking component comprising a plurality of groups that are reactive with the carbamate groups of component (a); and
(c) from about 10 to 30% by weight, based upon the weight of the binder, of a polymer microparticle dispersion.

14. A process for coating a substrate, comprising:
(a) applying a layer of a pigmented basecoating to the substrate to form a basecoat thereon;
(b) applying over said basecoat, a clearcoat layer comprised of a clearcoat composition;
(c) curing the basecoat and clearcoat to form a topcoat over the substrate,
wherein the clearcoat composition applied in step (b) comprises from about 40% to 80% by weight of film forming binder and from about 20% to 60% by weight of a volatile liquid carrier for said binder; wherein said binder comprises:
(a) from about 40% to 85% by weight, based on the weight of the binder solids, of a silane functional oligomeric or polymeric material comprising carbamate groups, prepared from a mixture comprising:
I) from about 10 to 85% by weight of polymerized monomers selected from the group consisting of an alkyl methacrylate, an alkyl acrylate, each having 1 to 12 carbon atoms in the alkyl group, cycloaliphatic alkyl methacrylate, cycloaliphatic alkyl acrylate, styrene or any mixture of these monomers;
II) from about 10 to 65% by weight of a mono-ethylenically unsaturated silane monomer;
III) from about 5 to 25% by weight of a mono-ethylenically unsaturated isocyanate monomer; and
IV) an effective amount of a mono-functional alcohol to react with the isocyanate group on said mono-ethylenically unsaturated isocyanate monomer; and
wherein said silane functional oligomeric or polymeric material comprising carbamate groups has a weight average molecular weight of 500 to 30,000, as determined by gel permeation chromatography;
(b) from about 15% to 60% by weight, based on the weight of the binder solids, of a crosslinking component comprising a plurality of groups that are reactive with the carbamate groups of component (a); and
(c) from about 10 to 30% by weight, based upon the weight of the binder, of a polymer microparticle dispersion.
